(19) United States
(12) Patent Application Publication
(10) Pub. No.: US 2018/0375897 A1
(43) Pub. Date: Dec. 27, 2018

(54) AUTOMATED NETWORK DEVICE CLONER AND DECOY GENERATOR

(71) Applicant: FORMALTECH, INC., Portland, OR (US)

(72) Inventors: Amelia Anjali Kawasaki, Portland, OR (US); Charles Nobuo Kawasaki, Portland, OR (US); Adam Cogen Wick, Portland, OR (US); James Dirksen, Portland, OR (US)

(21) Appl. No.: 15/975,444

(22) Filed: May 9, 2018

Related U.S. Application Data
(60) Provisional application No. 62/525,081, filed on Jun. 26, 2017.

(51) Int. Cl. H04L 29/06; H04L 12/26; H04L 12/24; G06F 9/455

(52) U.S. Cl. CPC H04L 63/1491; H04L 63/1433; H04L 63/1416; H04L 43/50; G06F 2009/45583; H04L 41/12; G06F 9/45558; G06F 2009/45595; H04L 41/145

(57) ABSTRACT

Methods and systems are provided for emulating devices communicating over a network. In one example, the method includes scanning real network devices by sending a network traffic, recording the network responses from the real network devices, and deploying unikernel-based virtual machines based on the recorded network responses. The unikernel virtual machines may respond to an external network scan based on the fingerprint files and the service files generated from the recorded network responses.

### CROSS REFERENCE TO RELATED APPLICATION

The present application claims priority to U.S. Provisional Application No. 62/525,081, entitled “Automated Network Device Cloner and Decoy Generator”, and filed on Jun. 26, 2017. The entire contents of each of the above-listed applications are hereby incorporated by reference for all purposes.

### FIELD

The disclosure pertains to computer and computer network security.

### BACKGROUND

Network and computer security has become increasingly important as businesses, individuals, and public agencies have adopted network and Internet-based tools for day to day activities. Many activities involve confidential personal information such as financial or medical records, business sensitive information or business critical systems, or information that is important for national security, defense and critical infrastructure. Such information and systems offer tempting targets to hackers, and protecting them from unauthorized access is an important concern.

Computer and network attacks related to unauthorized access to systems and information are based on a wide variety of tools and techniques such as scanning networks to find valuable assets, probing network nodes, and capturing and inspecting network traffic to find vulnerabilities. In some cases, so-called network scanning programs are used that can provide potential attackers with a road map of possible entry points. Moreover, in some cases, the goal of an attacker may be merely to swamp a network using a “denial of service attack” in which repeated requests for service are made. Many methods for defense against these and other attacks are available (e.g., cyber security systems), but they suffer from a variety of weaknesses, resulting in continued (and growing) reports of data breaches, theft of information, unauthorized access to systems, and denial of service. Weaknesses in existing systems include but are not limited to a) excess “false positives” where systems “cry wolf” falsely alerting to non-existent attacks, b) high expense in implementation, c) complicated configuration and management, d) incomplete protection, and e) high consumption of network resources.

As a result of these weaknesses, cyber security systems are often not implemented, implemented incorrectly, and/or not monitored and ignored when they generate too much information or too many false positives. Today, it is common that cyber-attacks on business networks are not detected for 100 days or more, and even then, only detected when reported by third parties such as law enforcement.

The present disclosure relates to the field of defensive systems known as honeypots (which may be alternatively referred to as honeynets). Honeypots are computers and networks installed by organizations seeking to provide valueless but “attractive” targets of attack for attackers. Ideally, attackers are lured into attacking the honeypot system, as opposed to a real computer or network of value. This spares the valuable assets, and the honeypots may be monitored for attacks, so that computer and network administrators may be alerted of attacks in progress.

In the past, honeypots have been classified as being either “high interaction” or “low interaction”. High interaction honeypots are typically real computers or devices that are fully functional, e.g., computers or servers running commonly deployed operating systems such as Windows, Linux, etc. This system may be purposely configured to implement vulnerabilities attractive to attackers, and may even implement network services or applications such as databases, web servers, and more. These systems require administration at the same level (or more) as a real information technology (IT) system.

“Low interaction” honeypots are software systems or devices that attempt to implement simulated devices or applications. These types of honeypots frequently use scripts to respond to network communication requests by attackers, implemented on top of general purpose operating systems. These honeypots typically have very limited functionality, and ultimately implement very poor fidelity emulations of real devices—making them easy to detect for attackers, and thus easy to work around and avoid.

Today, honeypots are rarely deployed in networks, and are not considered high-priority by cyber security defense teams. Instead, honeypots have been primarily relegated for use by cyber researchers. Further, honeypots are not currently listed as essential technology in industry standards cyber security frameworks such as NIST 800-53, or SANS TOP 20 security controls. The fundamental reason for this is that high-fidelity (high-interaction) honeypots are extraordinarily expensive and difficult to deploy at a scale necessary to effectively protect networks. Additionally, they are often designed with intentional vulnerabilities, which results in systems that must be watched/monitored very closely—driving up maintenance expenses and staff burden beyond affordable levels.

Several of the inventors of the present disclosure have previously developed honeypot technologies with high fidelity which faithfully reproduce the behavior characteristics of real computing devices on networks, while consuming in some cases only 1% of the comparable computing resources. These technologies make deployment-at-scale cost effective, expose far fewer cyber vulnerabilities, and enable management-at-scale through consolidated management techniques typically pre-existing in organizations, such as with the use of hypervisors (e.g., VMware, Hyper-V, Xen, etc.), software defined networking (SDN) controllers (e.g. CloudStack), containerization systems (e.g. Docker), and cloud systems (e.g. Amazon Web Services), all of which are hereafter referred to as Virtualization Systems. These technologies enable deployment-at-scale on very small computing platforms, in cloud instantiations, or in hybrid systems.

As used herein, honeypots comprise any number of ultra-small virtual machine (VM) instances, which instantiate simulated (fake) computers or network devices and are implemented via unikernel techniques. Each ultra-small VM instance will be referred to hereinafter as a “VM”. Each VM simulates a real device with high fidelity, and includes the following features:
a) An individually addressable network stack stored in non-transitory memory and configured to control the network interface between the fake device and the network itself. This enables each VM to be managed and integrated on a network using a wide variety of network infrastructure techniques, including providing support for Dynamic Host Configuration Protocol (DHCP), Virtual Local Area Networks (VLANs), and more.
b) A unique copy of code, stored in a single address space of non-transitory memory, which is configured to be compiled directly with only the minimum operating system services necessary to implement network communications, memory management, and task execution, and no more.
c) Code stored in non-transitory memory which is executable by a processor to implement a multi-personality network stack, service forwarding engine, packet capture and analysis system, network service emulation system, and communications protocols necessary to faithfully reproduce/simulate real devices.
d) Code stored in non-transitory memory which is executable by a processor to enable control and communications with external management and reporting systems.

Each ultra-small VM may be a unikernel-based VM, e.g., a single-address-space machine image constructed by using library operating systems. The unikernel-based VM may include each and every one of a thread management, an application memory management, and an OS library, and do not include a legacy operating system function. The legacy OS function may include one or more of a shell program, a file system, a user-space processes thread management, and an operation system utility. The VMs are generally configured to be instantiated by external controllers (typically embedded in or operatively integrated with Virtualization Systems), and commanded to simulate specific target devices (e.g., Windows Server, Cisco Router, etc.). With a configurable, multi-personality network stack, the VM can control network responses via the host computing device's network interface controller (alternatively referred to as network interface card or NIC), to simulate a specific device with high-fidelity—including responding to network requests from network scanners, vulnerability scanners, network tools and even applications, with correctly formatted or timed responses. Each VM can individually respond with hardware media access control (MAC) address information, layer 2 and layer 3 packets formatted in accordance with simulated operating system (OS) behavior, network services, or even application level protocols. By simulating OS behavior, the multi-personality network stack is able to successfully cause network scanning tools (that typically contain a set of expected OS response behaviors or “fingerprints”) into reporting that the VM is of a specific device type or running a specific OS, even though the response from the VM is only a simulated response.

In addition to simulating OS behavior, the VMs can also simulate well known and popular network services (e.g., Hypertext Transfer Protocol (HTTP) for Web Servers, Secure Shell (SSH) for remote shell/command line access, Simple Mail Transfer Protocol (SMTP) for email transmission, etc.), as well as custom services that may have been created internally by an organization, further improving the fidelity of VMs. The services can respond to connection attempts by replaying pre-recorded transactions, or can include partial or complete implementations of real services, depending on the required level of fidelity. The inclusion of emulated services enables the VMs to simulate services that attackers expect to see in a specific device, and can include simulated vulnerabilities that entice attackers to attempt connection to the VM.

The techniques described above enable the large scale deployment of lightweight honeypots, using a graphical user interface (GUI) for receiving input from a human operator, or may be integrated with automated deployment means. The automated system enables maximum fidelity of the simulated honeypots at very large scale, updated in real-time.

### SUMMARY

The disclosed methods and apparatus implement automated systems for networking discovery, fingerprint generation and service recording that can processes some or all devices on a network, for the purpose of automatically (or semi-automatically) duplicating (cloning) a wide array and large numbers of real devices on a network, and deploying the cloned devices on the network. This system enables network administrators and security administrators to create large, realistic (but fake) attack surface areas, with a minimum of effort, and to maintain the fidelity of the surface area over time, even as changes are made to the real network and network devices. The system may be configured to automatically duplicate, deploy, and update cloned devices, the cloned devices hosted on individual servers residing in private networks, hosted in public or private cloud infrastructure, and/or hosted by Internet Services Providers (ISPs) and/or Cloud Providers on behalf of their customers, in multi-tenant environments.

For example, an apparatus in accordance with the present disclosure may comprise a software program running on a host computing device or computing infrastructure and connected to an organization's network, including the following features:
a) Code stored in non-transitory memory which is executable by a processor to perform a controlling process to process user input (such as Internet Protocol (IP) address ranges), through a command line interface, or through a graphical user interface (GUI). Or, to process input provided by an external program or script through a command line interface or through an application programming interface (API). The initiation of the process may be triggered through any number of causes including external triggering systems including but not limited to scheduled execution (based on calendar schedule or periodic schedule—e.g., hourly) and event triggering (such as through detection by external network inventory systems, IP address management systems, or authentication systems of new devices added to a network or changes to systems discovered by vulnerability management systems or host-based Intrusion Detection Systems (IDSs)). The process may also be initiated from Virtualization Systems or their controllers, when new non-clone VMs are added to the network).
b) Code stored in non-transitory memory which is executable by a processor to perform a controlling process which iterates through network IP address ranges that represent target real network devices to clone, and that controls the following subsystems.
1. A discovery engine used to probe each real network device in the range and to characterize the OS of the real network device. For example, the discovery engine may accomplish OS characterization of the real network device by sending the real network device various Transmission Control Protocol (TCP) and User Datagram Protocol (UDP) network packets, and analyzing responses from the real network device which uniquely identify the OS of the real network device, such as various bit patterns in responses, timing characteristics of responses, etc. Other methods for characterizing the OS of the real network device may include querying services such as HTTP, and analyzing results.
2. A traffic generation engine (that may or may not be the same as the discovery engine) used to discover and communicate with available network services on a real network device. The traffic generated by the traffic generation engine may include a variety of means to initiate network communications with the real devices, using software- or hardware-based systems to initiate communications protocols, typically starting with connection requests. The generation engine may simulate protocols, use scripting engines to generate protocols, or use full-featured protocol implementations when communicating with real devices. Example protocols include HTTP, Hypertext Transfer Protocol Secure (HTTPS), Network Time Protocol (NTP), Simple Network Management Protocol (SNMP), NetBIOS, etc.
3. A traffic recording engine that records the network service communications between the traffic generation engine and the network services on the real network devices.
4. A fingerprint manipulation/conversion engine that receives the results of the discovery engine and processes and converts the fingerprints into forms suitable for use by the honeypot system. This step may include binary or textual conversions, and/or heuristic or filtering approaches to translate fingerprints from discovery engine, thereby enabling the system to utilize engines of different types that may generate fingerprints in different formats, and then convert the fingerprints into a single standard format consistent with the needs of the honeypot system.
5. A network services manipulation/conversion engine that receives the results of the traffic recording engine and processes and converts the network services recordings into forms suitable for use by the honeypot system. Converting the network services recordings into forms suitable for use by the honeypot system may include conversion of network service recordings from multiple sources. For example, the network services manipulation/conversion engine may further identify parts of the service recordings that could be parameterized in order to improve cloning fidelity. Examples of parts of the service recording to parameterize include information such as date, time-of-day, and real device IP addresses or other identifiers. This information may be marked for replacement during the honeypot service playback process. As an example of how parameterizing date and time information may improve cloning fidelity, if a service is recorded at a given date and time, then played back at a further date and time (e.g., 1 month later), the dates will be incorrect and suspicious if the protocol has embedded dates that are not updated at playback time.
c) A controlling process that can automatically, or with manual intervention, name and install fingerprints and services into the above described honeypot system, ready for use.
Upon completing the installation of fingerprints and services into the honeypot system, the controlling process may communicate to the Virtualization Systems and their controllers to indicate that new fingerprints/services are available, and indicate a variety of actions that may be taken by the Virtualization Systems to maintain fidelity. Such actions include: instantiation of new fake devices to mirror the newly cloned devices, instantiation of new services on existing fake devices, and updating/replacing fingerprints or services. The Virtualization Systems may stop/start/restart fake devices as necessary to achieve the results.

The system can be deployed in the form of application software installed by users on Personal Computers (PCs)/Laptops, Servers, or the Cloud, or it can be bundled with hardware computing hosts and deployed as appliances, ready for connection to a network. The system can be offered as a managed service as well.

The system can be implemented using a variety of user interface techniques, including through thin-client, web-based, or thick client variants. The system may also be entirely headless, that is, without a user interface—instead being driven by information technology automation systems or external programs, through command line or APIs. The system may be invoked on a regular schedule or through external triggers (such as by systems that can automatically detect network changes).

The system may be composed of an entirely self-contained and integrated set of software, or may rely on a variety of external and even 3^{rd} party software applications or hardware systems to perform any of the described tasks. The system may use any means to communicate with subsystems including command lines, APIs, OS shell scripts, etc.

### BRIEF DESCRIPTION OF THE DRAWINGS

FIG. 1 is a block diagram of a network including network devices, honeypots and the network cloning apparatus in accordance with the present disclosure.

FIG. 2 is a block diagram of a computing device which may be used as the honeypot system shown in FIG. 1, for example.

FIG. 3 is a block diagram of a software application which implements the apparatus shown in FIG. 1 and which may be hosted on a host computing device, for example.

FIG. 4 is a flow chart illustrating a method for discovering and cloning network devices, which may be carried out by the software application shown in FIG. 3 in conjunction with user input received via a GUI.

FIG. 5 is a flow chart illustrating a method for displaying discovered fingerprints and services, for selection and use by users of the software application, which may be carried out by a software application, such as the software application shown in FIG. 3.

FIG. 6 is a flow chart illustrating another method for discovering and cloning network devices, which may be carried out by the software application shown in FIG. 3 in an automated manner responsive to detection of a network change via the external triggering system.

FIG. 7 is a flow chart illustrating a method for automatically detecting fingerprints/services, filtering the detected fingerprints/services, and adding the detected fingerprints/services to a honeypot system depending on the results of the filtering, which may be carried out in an automated manner by a software application, such as the software application shown in FIG. 3.

FIG. 8 is a screen image of a GUI of a software application providing the ability for users to input network IP address ranges to discover and clone.

FIG. 9 is a screen image of a GUI of a software application providing status information during the discovery process.

FIG. 10 is a screen image of a GUI of a software application providing a list of discovered devices, fingerprints and services, by network IP address.

FIG. 11 is a screen image of a GUI of a software application displaying the detailed contents of a fingerprint, in an inspect screen.

FIG. 12 is a screen image of a GUI of a software application providing the ability for users to manually save and name fingerprints (e.g., in the form of fingerprint files) or services (e.g., in the form of service files) into the honeypot system.

FIG. 13 is a block diagram of an example of ultra-small virtual machine which may be included in the network shown in FIG. 1 and hosted on the computing device shown in FIG. 2, for example.

### DETAILED DESCRIPTION

As used in the present disclosure, the singular forms “a,” “an,” and “the” include the plural forms unless the context clearly dictates otherwise. Additionally, the term “includes” means “comprises.” Further, the term “coupled” does not exclude the presence of intermediate elements between the coupled items. However, the term “directly coupled” does exclude the presence of intermediate elements between the directly coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

Disclosed herein are methods and apparatus for the duplication of network device operating system fingerprints and network services by lightweight, scalable honeypot systems, which serves to maximize the deception of the honeypot systems. In one example, the apparatus is implemented as installable software or software residing on an appliance or on the Cloud, and is configured to scan a network of devices, find real network devices and probe them to determine their fingerprints, and generate network traffic sufficient to record the network interactivity of the real network devices and also enable the simulation of such responses by the lightweight honeypots.

One goal of providing an automated scanner is to allow users and integrators (or developers) of the honeypots to quickly and easily populate the apparent attack surface of a network with devices that appear to be “real” devices, even though they are simulated—including recording of fingerprints and services of unique, customized devices. The recordings may include network responses that contain customer specific information (machine names, etc.), further improving the fidelity of the responses.

Some aspects of methods and systems that can address some or all of these goals are set forth below.

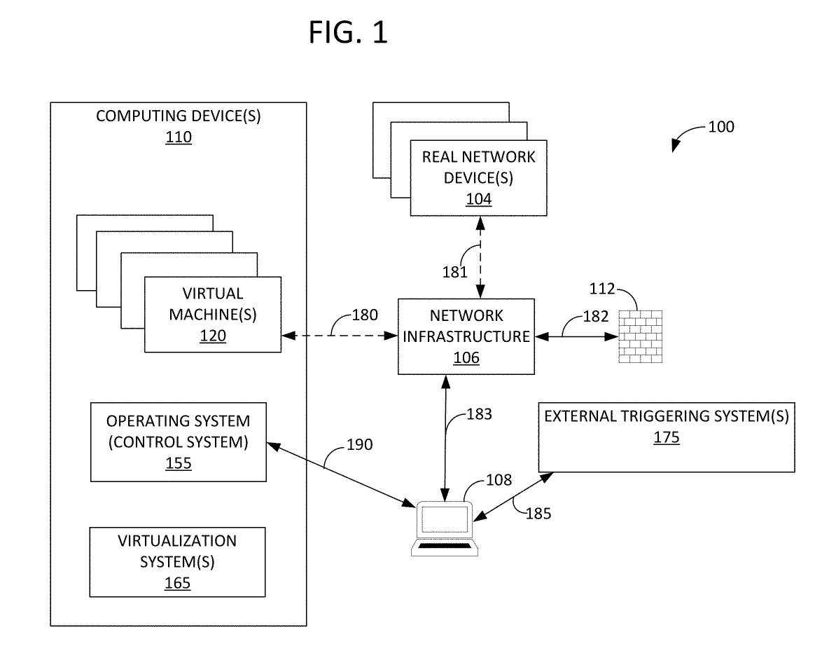

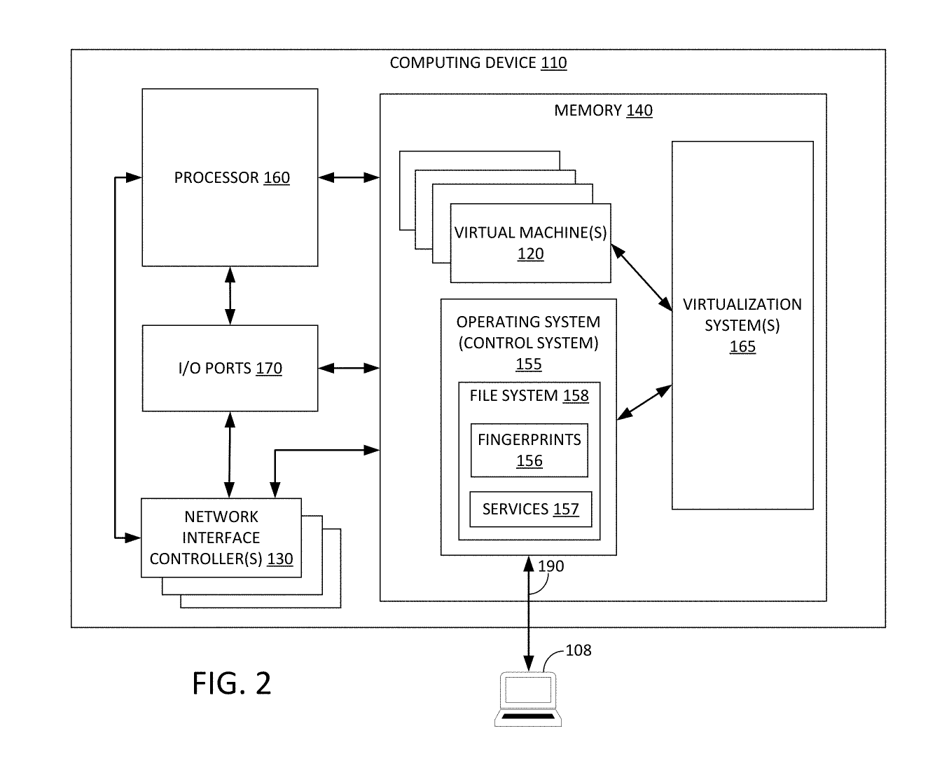

FIG. 1 shows a block diagram of a network 100. Network 100 includes one or more real network device(s) 104; network infrastructure 106; firewall 112; external triggering system(s) 175; host computing device 108; and one or more computing devices 110; an exemplary computing device 110 is shown in FIG. 2. Network 100 further includes one or more VMs 120 generated and deployed at one or more of computing devices 110. VMs 120 may optionally communicate with network infrastructure 106 via a network connection 180. Real network device(s) 104 may optionally communicate with network infrastructure 106 via a network connection 181. Network infrastructure may communicate with firewall 112 via a network connection 182. Network infrastructure may communicate with host computing device 108 via a network connection 183. External triggering system(s) 175 may communicate with host computing device 108 via a network connection 185.

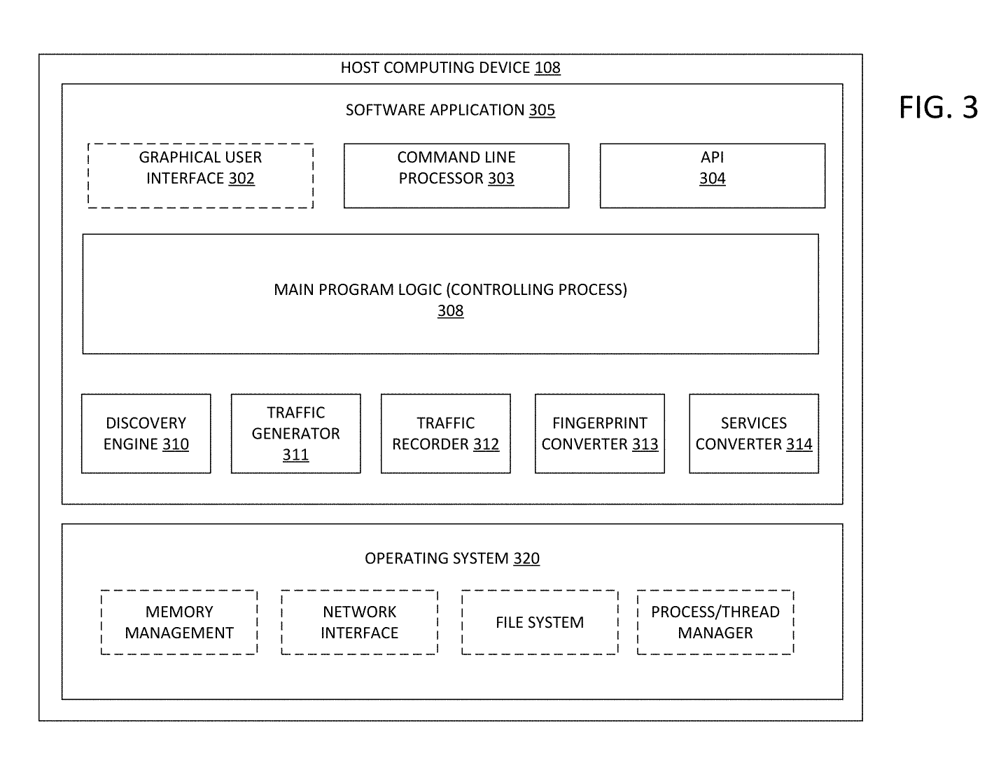

Host computing device 108 may perform one or more of the methods described herein, and may include, or be coupled to and/or in communication with, various hardware components as well as software applications. An exemplary host computing device 108 is shown in FIG. 3. While a single host computing device 108 is shown in FIG. 3, in other examples the network may include multiple host computing devices (e.g., first and second host computing devices).

In the depicted example, each computing device 110 includes an operating/control system 155 which communicates with host computing device 108 via a network connection 190, one or more virtualization systems 165, and virtual machines 120.

The operating system 155 may process commands to manage devices via a command. The operating system 155 may receive the command via a command line interface, a GUI, or programmatic API (such as the GUI 302, command line processor 303, and API 304 of host computing device 108 of FIG. 3. The command may be sent to the operating system 155 from host computing device 108 via network connection 190. The operating system 155 may communicate with the virtualization system 165 that carries the VM control functions at the hypervisor layer.

The virtualization system(s) 165 may include hypervisors (e.g., VMware, Hyper-V, Xen, etc.), SDN controllers (e.g. CloudStack), containerization systems (e.g. Docker), and cloud systems (e.g. Amazon Web Services). Each virtualization system may include a controller embedded therein, or alternatively a controller may be external to but operatively integrated with the virtualization system(s). The controller may include instructions stored in non-transitory memory which are executable by a processor to instantiate new fake devices to mirror cloned devices, instantiate new services on existing fake devices, and update/replace fingerprints or services. The controller may further include instructions to stop/start/restart fake devices as necessary to achieve desired results.

External triggering system(s) 175 may include software programs running on computers or servers that inspect network traffic, monitor networks, and scan network devices. For example, the external triggering system(s) may use a network interface to scan the network; scanning the network may include scanning network packets by monitoring traffic on the network. In some examples, the external triggering system(s) are placed “in-line” (e.g., configured to receive network packets and forward the network packets to their destination), so that they can monitor and even block network traffic. In some examples, the external triggering system(s) may be configured to automatically detect network changes. This may include detecting network changes based on a calendar schedule or periodic schedule, via external network inventory systems, IP address management systems, and/or authentication systems of new devices added to a network, and/or via changes to systems discovered by vulnerability management systems or host-based IDS systems.

In other examples, the external triggering system(s) may include dedicated, hardware-based network devices, such as firewalls, routers, packet capture devices, etc. The network devices may include custom, dedicated hardware for performing the functionality discussed above. The network devices may also include firmware or embedded system software to control the device logic.

In operation, when the external triggering system(s) detect a network event of interest, as configured with rules by administrators, they can send messages with information of the event to the network cloning system over the network using protocols (e.g., Syslog or other alerting protocols). The messages may include the IP addresses of newly discovered devices on the network, thereby indicating to the network cloning system that the devices should be scanned/recorded/cloned and that the fingerprints/services from those devices should be added to the honeypot system.

Thus, the external triggering system(s) may detect new devices added to a network through various means, and then supply the IP addresses of those devices to the network cloning system through a variety of means, including embedded in-network messages via alert/log protocols (e.g., Syslog), or through network control and management protocols (e.g., SNMP). The external triggering system(s) may also may use remote procedure calls (RPC) to invoke the network cloning process, supplying the IP addresses through RPC standards such as SOAP, or RESTful APIs. Through these methods, the external triggering system(s) may reside on the same system (e.g., physical device) as the cloning system, or may reside on any other host computer platform or networking appliance attached to the network, or operatively coupled to the network cloning system via other connections such as with serial ports.

As shown in FIG. 2, an exemplary computing device 110 includes a processor 160, a network interface controller (NIC) 130 enabling communication over a network, memory 140 having a virtualization system 165, one or more VMs 120 stored therein and an optional operating system serving as a control system 155, and input/output (I/O) ports 170. Non-limiting embodiments of computing device 110 may include embedded devices, standalone devices, network appliances, clustered devices, compute-as-a-service, or cloud infrastructure.

Memory 140 of computing device 110 comprises non-volatile memory which stores data such as instructions executable by a processor (e.g., processor 160 and/or NIC 130) in non-volatile form. Memory 140 may further comprise volatile memory, such as random access memory (RAM). Non-transitory storage devices, such as non-volatile and/or volatile memory of memory 140, may store instructions and/or code that, when executed by a processor (e.g., processor 160 and/or NIC 130), controls the computing device to perform one or more of the actions described in this disclosure.

As shown, the virtualization system 165 is stored in memory 140. Virtualization system 165 may be a piece of computer software, firmware, or hardware that creates and deploys VMs 120 which each appear on a network as a discrete device, and which share a limited number of physical network interfaces. In one example, virtualization system 165 is a hypervisor implemented by a software program such as VMware, Hyper-V, or Xen.

Each NIC 130 may be operatively coupled to network drivers of one or more VMs 120, thereby providing network connectivity. Computing device 110 may include a single NIC, a first NIC and a second NIC, or any other appropriate number of NICs (e.g., one NIC per VM, or one NIC serving multiple VMs). NICs 130 may be wired or wireless, and/or may include any physical medium capable of transmitting data including IP communications.

Fingerprints 156, in the form of fingerprint files, may be loaded on and stored in a file system 158 of operating system 155, controlled by the operating system 155, and used by VMs 120 to simulate the fingerprints of real devices, e.g. the fingerprints of real devices recorded at host computing device 108. For example, the VMs may use the analyzed results of TCP and UDP packets sent during the discovery process, and transmit responses to attempts to communicate with the VMs, using the analyzed results.

Services 157, in the form of service files, may be loaded on and stored in the file system 158, controlled by the operating system 155, and used by VMs 120 to simulate the network services of real devices, e.g. the network services of real devices recorded at host computing device 108. The VMs may transmit network protocols and packet contents as recorded during the service recording process. The playback of network services may include substituting parameterized values into the recorded services, thereby ensuring that items such as date, time-of-day, IP addresses and other information is current and active.

In some examples, services 157 and other common or custom services. For example, a fake device providing an HTTP service may provide fake web pages as recorded from real web servers discovered and recorded during the service recording process.

FIG. 3 depicts a block diagram of an exemplary host computing device 108 hosting a software application 305, with subsystems thereof implementing major functional blocks. The comments for executing the software application may be stored in non-transitory memory of the host computing device, and the host computing device may further comprise a processor for executing the commands. The software application may be a single integrated software application. The software application may comprise a plurality of modules or executables invoked through APIs or OS commands. The software application may rely on services provided by the operating system 320 for access to the hardware devices inside the host computing device 108, such as storage devices (disk drives, etc.), network interface devices, and memory, as needed to complete its tasks. In the depicted example, the software application includes the following components:
a) An optional GUI module 302 providing a means for users to enter input, monitor progress, and review and manipulate the results of cloning tasks performed by the software application. The GUI may be displayed using any type of windowing system, such as Microsoft Windows, Apple Mac OS, a Linux Graphic Desktop Environment, an HTML Web UI, etc.
b) A command line processor interface module 303 that accepts and processes commands (typically typed in by users) directing the software application to perform tasks as directed, and that reports results.
c) An API interface module 304 that accepts and processes commands from external software programs, directing the software application to perform tasks as directed, and that returns results.
d) A main program logic (controlling process) 308 that performs the cloning tasks as directed by the interface modules 302, 303 or 304, dispatching subtasks such as a discovery engine 310 in order to clone one or more real network devices. The controlling process may use single threading or multi-threading in order to improve performance, relying on services provided by the operating system 320 as required. The subtasks such as discovery engine 310 and traffic generator 311 may be embedded modules or external libraries or programs, including 3^{rd} party programs. The controlling process 308 communicates results to the interface modules, for manipulation by a user of host computing device 108.
e) A discovery engine 310 subtask used to find and probe real network devices, to create initial fingerprints of real network device operating systems.
f) A traffic generator 311 subtask used to generate network traffic that causes real network devices to respond via their network services. This may be independent of the discovery engine, or combined with it. In one example, the generated network traffic may include network protocol and network packets. The network protocol and networks packets may be TCP and UDP for determining fingerprints of the real network devices. The network protocols may include a wide array of protocols such as HTTP, SSH, SNMP, and SMB for determining services of the real network devices.
g) A traffic recorder 312 subtask used to capture network services responses from real network devices, in order to create a service files to be used by the virtual machines.
h) A fingerprint converter 313 subtask, used to convert, filter and adapt the fingerprints generated by the discovery engine 310, if necessary, in order to create fingerprint files for use by the honeypot system.
i) A services converter 314 subtask, used to convert, filter and adapt the network services recorded by the traffic recorder 312, if necessary, for use by the honeypot system.

The operating system 320 may be any general purpose operating system that provides the suite of services necessary to interface to devices in the host computing device 108, such as Microsoft Windows, Linux, Mac OSX, Android, etc. Services typically used include memory management, thread/process management, access to the file system, network interfaces, display adapters, etc. The software application may utilize those services though native OS function calls, libraries, command lines or other means.

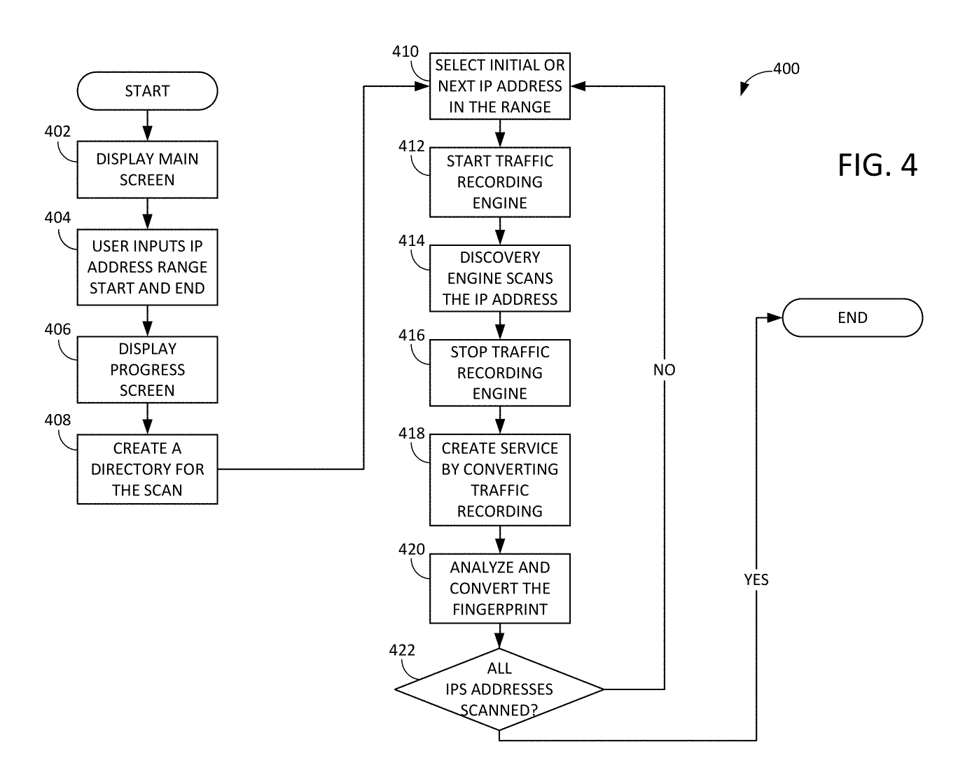

FIG. 4 shows a method 400 for a software application, through a GUI, to discover and clone multiple network devices. In one example, method 400 may be performed by host computing device 108 shown in FIG. 1 and FIG. 2.

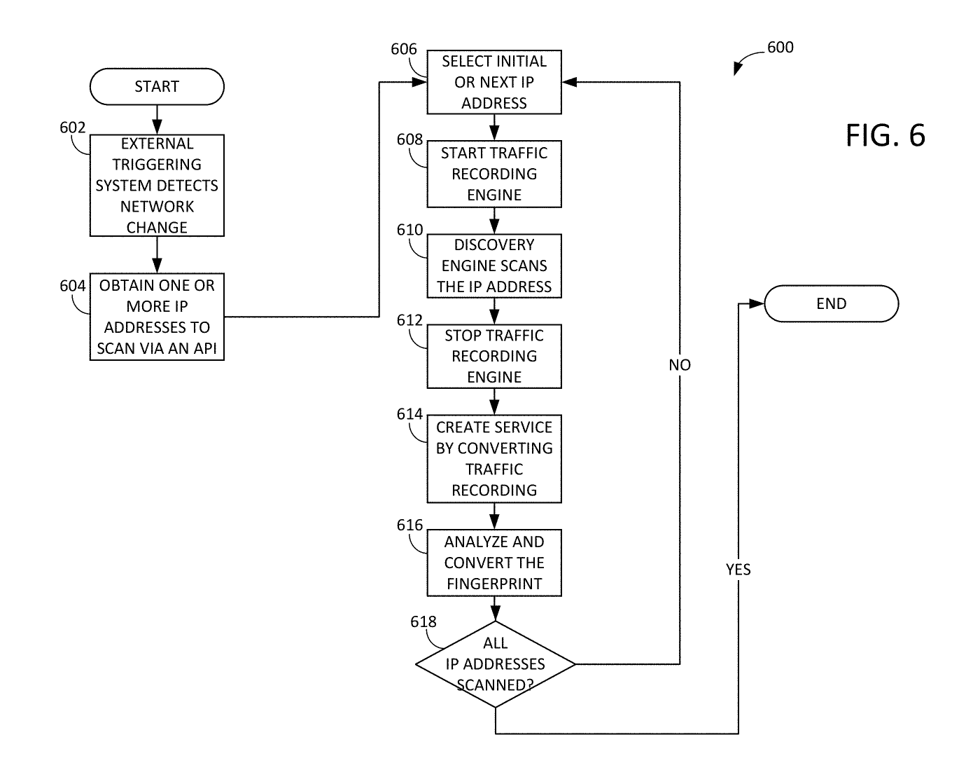

On application software start, the method proceeds to 402 and displays a main screen (shown in FIG. 6).

At 404, a user of the software application enters start and end IP address ranges, which the software application then scans to find the real network devices to clone. In one example, each real network device has one unique IP address.

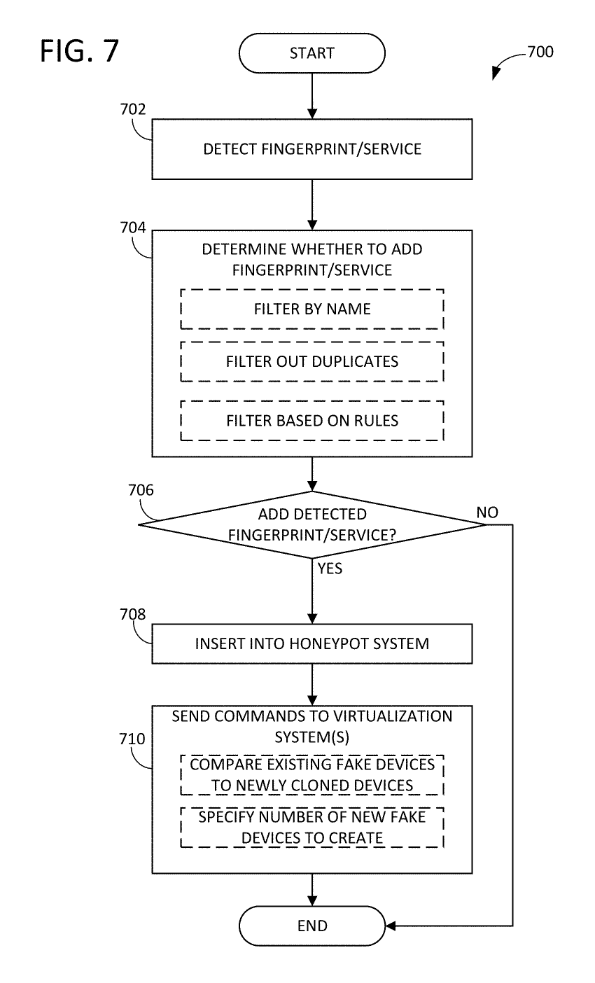

At 406, the method includes displaying a status/progress screen (shown in FIG. 7).

At 408, the method includes creating a storage location (e.g., a directory) for recording of intermediate results of the scan.

At 410, the method includes selecting a first IP address from the IP address range provided by the user.

At 412, the method includes starting to record network traffic, e.g. via the traffic recorder 312 shown in FIG. 3.

At 414, the method includes scanning the first IP address, e.g. via discovery engine 310 shown in FIG. 3 and optionally via traffic generator 311 of FIG. 3, if the traffic generation is a separate process from the fingerprint scanning. The first IP address may be scanned by generating a network traffic targeting the first IP address. The network traffic (using TCP and UDP) for identifying the fingerprint of the real network device with the first IP address may be generated by the discovery engine 310. The network traffic for identifying the services of the real network device with the first IP address may be generated by the traffic generator 311. The network traffic for identifying the finger print and the network traffic for identifying the service may use different protocols. The network traffic response from the real network device with the first IP address may be recorded. The discovery engine 310 may analyze these response to determine the fingerprint. The network traffic response from the real device may also include network services, which may be recorded with the traffic recorder.

When the scan completes, the method proceeds to 416 and stops recording the network traffic response.

At 418, the method includes processing the recorded network traffic response. This may include creating one or more service files via conversion of the recorded network service from the real network device. The conversion may be performed by services converter 314 of FIG. 3. As described above this conversion may perform text/binary conversion of data into a standard format for playback, and parameterize the recording to indicate parts of the protocols to substitute at runtime with then-current information.

At 420, the method includes analyzing and converting fingerprints recorded during the traffic recording. This may include converting recorded fingerprints into fingerprint files via fingerprint converter 313 of FIG. 3.

At 422, the method includes determining whether all IP addresses have been scanned. If the answer at 422 is NO, the method returns to 410 and selects the next IP address in the user-supplied range. In this way, the method of FIG. 4 proceeds, iterating through all IP addresses in the user-supplied range. Once all IP addresses have been scanned and processed, the answer at 422 is YES, and the method ends.

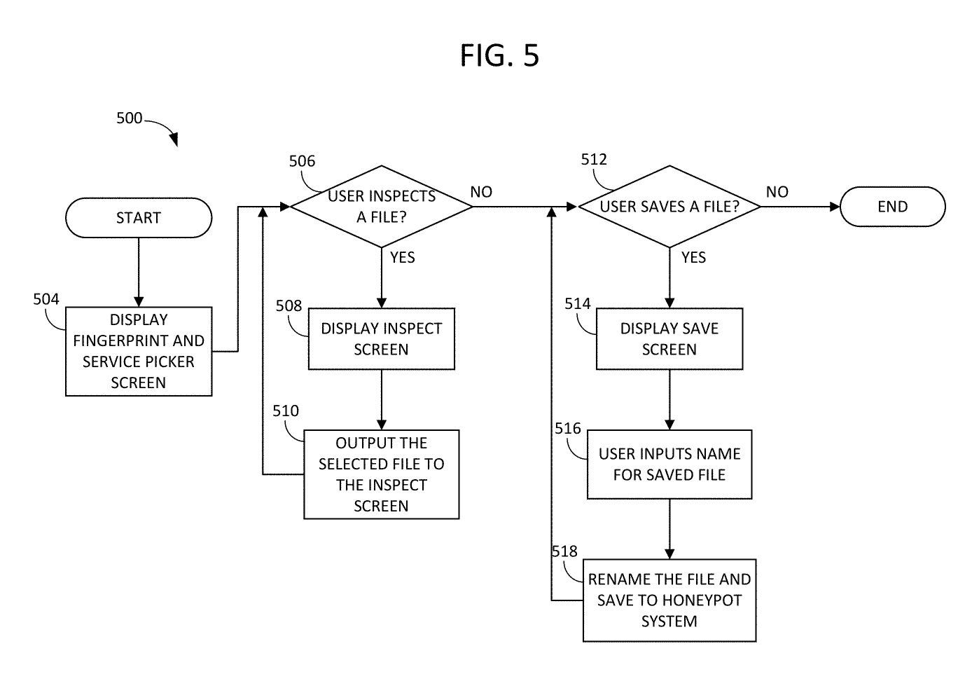

FIG. 5 shows a method 500 for a software application, through a GUI, to enable users to inspect, name and save fingerprints and services into the honeypot system. In one example, method 500 may be performed by host computing device 108 shown in FIG. 1 and FIG. 2. Method 500 may be performed immediately following method 400, such that the services and fingerprints recorded and converted via method 400 may be inspected, named and saved into the honeypot system via method 500.

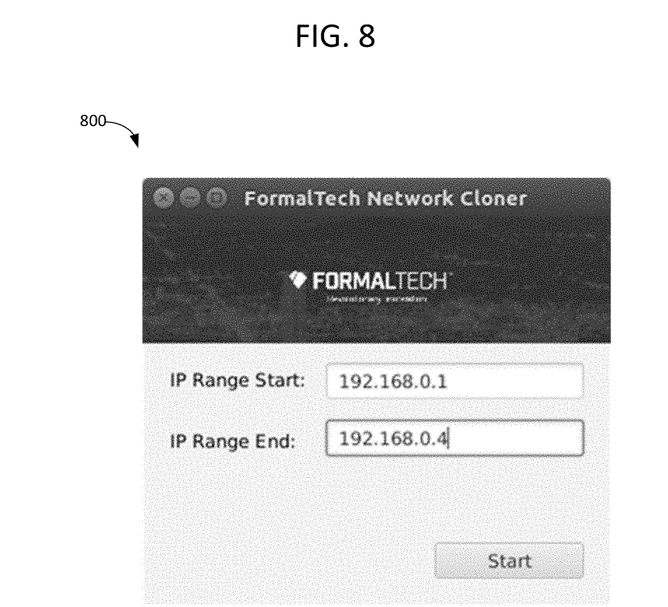

At 504, method 500 includes displaying the lists of fingerprint files and service files generated by method 400. An example screen displaying the lists of fingerprint files and service files, which may be referred to as the fingerprint and service picker screen, is shown in FIG. 8. On this screen, users may either (1) select a fingerprint file or service file for inspection, or (2) save a fingerprint file or service files.

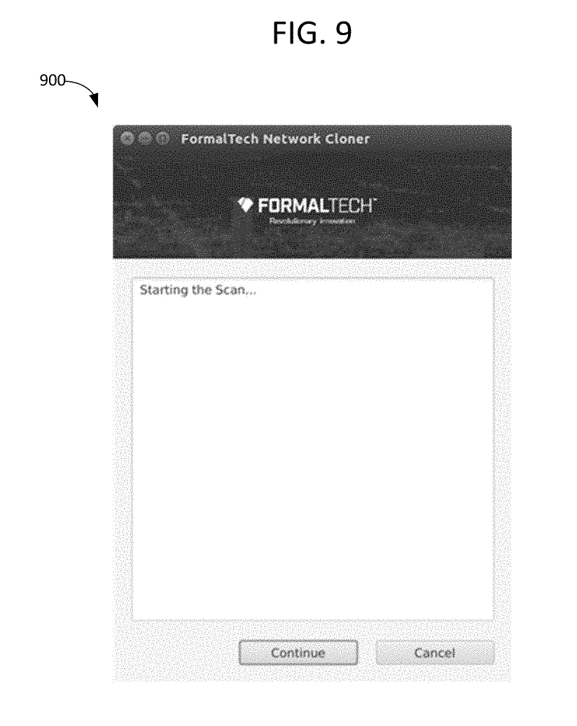

At 506, the method includes determining whether the user has selected a file (either a fingerprint file or a service file) to inspect. If the answer at 506 is YES, the method proceeds to 508 to displays an inspect screen (such as the screen shown in FIG. 9) and then to 510 to output the selected fingerprint file or service file to the inspect screen. This allows the user to review detailed contents of the fingerprint file or service file.

Otherwise, if the answer at 506 is NO, the method proceeds to 512 and determines whether the user has saved a file (either a fingerprint file or a service file) into the honeypot system. If the answer at 512 is YES, indicating that the user has selected a file to save (either a fingerprint file or a service file), the method proceeds to 514 and displays a save screen (such as the screen shown in FIG. 9). The save screen enables the user to rename the fingerprint file or service file with an easy-to-identify name of the user's choice.

At 516, the user inputs the desired name for the saved file. Once the user types in the name, the method proceeds to 518 to save the file to the honeypot system at the appropriate location in the memory of the computing device (e.g., computing device 110 shown in FIG. 2). For example, service files may be saved to location 157 shown in FIG. 2, and fingerprint files may be saved to location 156 shown in FIG. 2, by the software application residing on host computing device 108.

Returning to 512, if the answer is NO, the method ends.

FIG. 6 shows a method 600 for a software application to automatically (e.g., not directly responsive to user input) discover and clone multiple network devices. Thus, whereas method 400 discovers and clones multiple network devices responsive to user input via a GUI, method 600 may be initiated and executed automatically and independent of user input, e.g. at predetermined intervals or responsive to external triggers. In one example, method 600 may be performed by host computing device 108 shown in FIG. 1 and FIG. 2.

At 602, method 600 includes detecting a network change with the external triggering system. For example, as discussed above, this may include detecting network changes based on a calendar schedule or periodic schedule (e.g., detecting network changes while performing a scan at a scheduled time), via external network inventory systems, IP address management systems, and/or authentication systems of new devices added to a network, and/or via changes to systems discovered by vulnerability management systems or host-based IDS systems.

After 602, the method proceeds to 604. At 604, the method includes obtaining one or more IP addresses to scan via an API. For example, an API interface module may receive one or more IP addresses to be scanned from an external triggering system (e.g., software program), such as external triggering system 175 discussed above.

The remaining steps of method 600 are identical to method 400 at 410-422.

FIG. 7 shows a method 700 for automatically detecting fingerprints/services, filtering the detected fingerprints/services, and adding the detected fingerprints/services to a honeypot system, to then be used by newly created or existing VMs to emulate the newly found fingerprints/services depending on the results of the filtering. In one example, method 700 may be performed by host computing device 108 shown in FIG. 1 and FIG. 2. In some respects, method 700 is an automated version of the method 500. Method 700 may be performed independent of user input.

At 702, method 700 includes detecting a fingerprint/service. The detection of the fingerprint or service may be carried out in accordance with method 600, in some examples.

At 704, the method includes determining whether to add the detected fingerprint/service to the honeypot system. The determination may be based on settings/rules created by administrators in configuration files, through a setup GUI, etc. Further, the determination may optionally include filtering the detected fingerprint/service by name (e.g., only adding fingerprints/services with names meeting certain criteria), filtering out duplicates (e.g., filtering out the detected fingerprint/service if it is a duplicate of an already-existing fingerprint/service of the honeypot system, and/or filtering the detected fingerprint/service based on rules (e.g., excluding all fingerprints/services except for those meeting specific inclusion rules, and/or only adding certain new types of fingerprints/services). The rules may include rules to eliminate duplicates, rules to filter out fingerprint or services by name or type, as well as other rules filtering out devices from being cloned which can be applied to any discoverable property of the recorded device (e.g., IP address, Media Access Control (MAC) address, or other information from packet headers sent from the device). The rules can also be applied to the packet contents, including packet contents from the service recording. As one non-limiting example, devices may be ruled out if they perform services that return data inside packets that match specified text strings, expressions, or hashes.

After 704, the method proceeds to 706. If it was determined at 704 that the detected fingerprint/service should be added to the honeypot system, the answer at 706 is YES, and the method proceeds to 708. Otherwise, the answer at 706 is NO and the method ends.

At 708, method 700 includes inserting the fingerprint/service into the honeypot system. For example, a file including the fingerprint/service may be saved to the honeypot system, to then be used by newly created or existing VMs to emulate the newly found fingerprints/services. The fingerprints/service may be inserted to the honeypot system by the main program logic 308 of FIG. 3, which in turn causes operating system 155 of computing device 110 of FIG. 2 to store fingerprints/services into is file system 158.

After 708, the method proceeds to 710 to send commands to the operating system 155 of computing device 110 of FIGS. 1-2. The commands may include commands to compare the existing fake devices to the newly cloned devices, to determine if only updates to existing fake devices are needed. Further, the commands may specify the number of new fake devices to create based on provided conditions (e.g., create 10 new fake devices for every new OS found). After 710, method 700 ends.

FIG. 8 shows a screen image 800 of a GUI of a software application providing the ability for users to input a network IP address range to discover and clone. The GUI includes input fields for the start and the end of the IP range to specify which IP addresses the program should discover. The GUI also contains a start button to indicate the end of user input and to start the program.

FIG. 9 shows a screen image 900 of a GUI of a software application providing status information during the discovery process. The GUI displays a message indicating the scan is progressing and a message indicating the scan has finished after all of the IP addresses have been discovered. Optionally, the output from the underlying engines can be displayed in the GUI during the scan's duration or saved to an external log file after the scan has finished. Once the message indicating the scan has finished is displayed, the user can press the continue button to move on. The user can also press the cancel button at any point during the scan to cancel the scan and close the window.

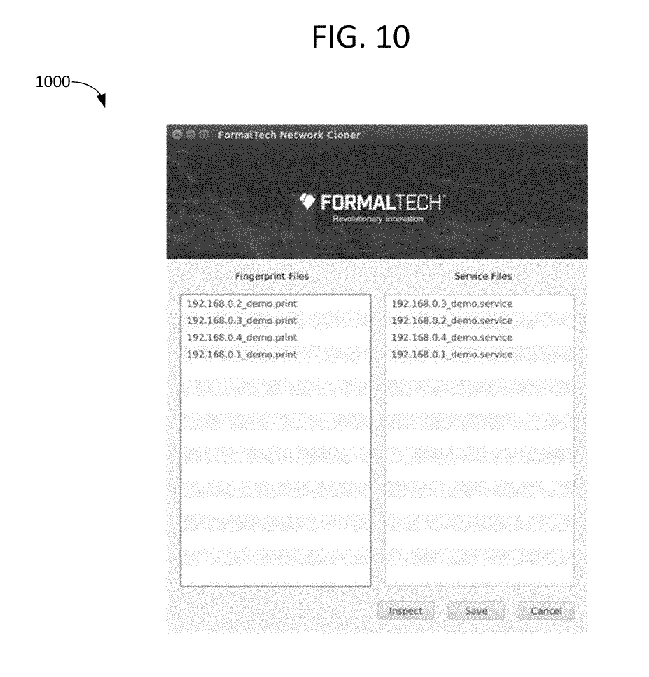

FIG. 10 shows a screen image 1000 of a GUI of a software application providing a list of discovered fingerprint files and service files by network IP address. The user can select a fingerprint file or service file from the display and press the inspect button to open the inspect window. The user can also choose to save a selected fingerprint file or service file by pressing the save button, opening the save window. The user can also cancel and close the window.

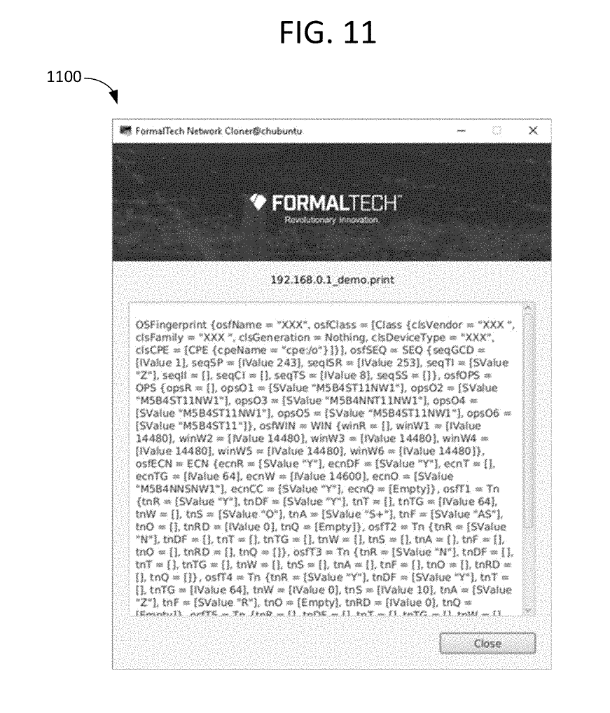

FIG. 11 shows a screen image 1100 of a GUI of a software application displaying the detailed content of a fingerprint file, in an inspect screen. The contents of the single fingerprint file or service file selected on the screen shown in FIG. 8 is displayed in a scrollable display with the name of the fingerprint file or service file displayed at the top. The GUI includes a close button for the user to press when they are done inspecting the contents.

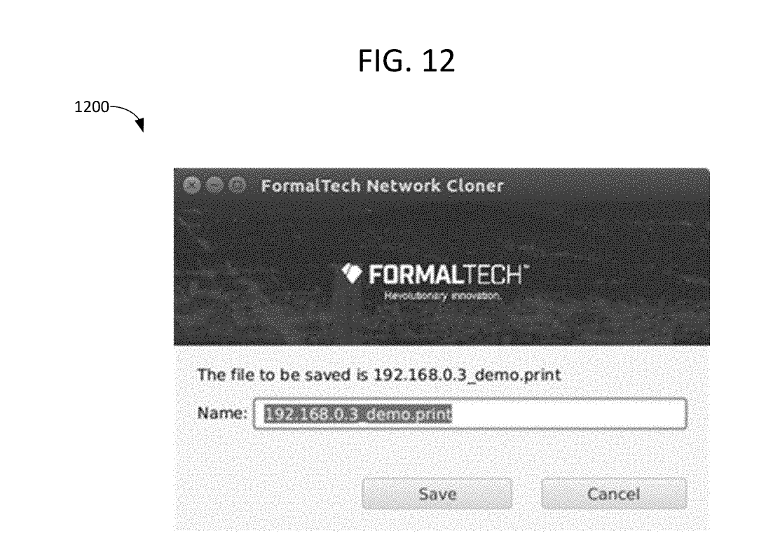

FIG. 12 shows a screen image 1200 of a GUI of a software application providing the ability for users to manually save and name a fingerprint file or service file into the honeypot. The GUI displays the current name of the fingerprint file or service file at the top of the screen. It also allows the user to input a new name for the selected file and save the file by pressing the save button. The user can also choose to cancel the save action by pressing the cancel button and closing the window.

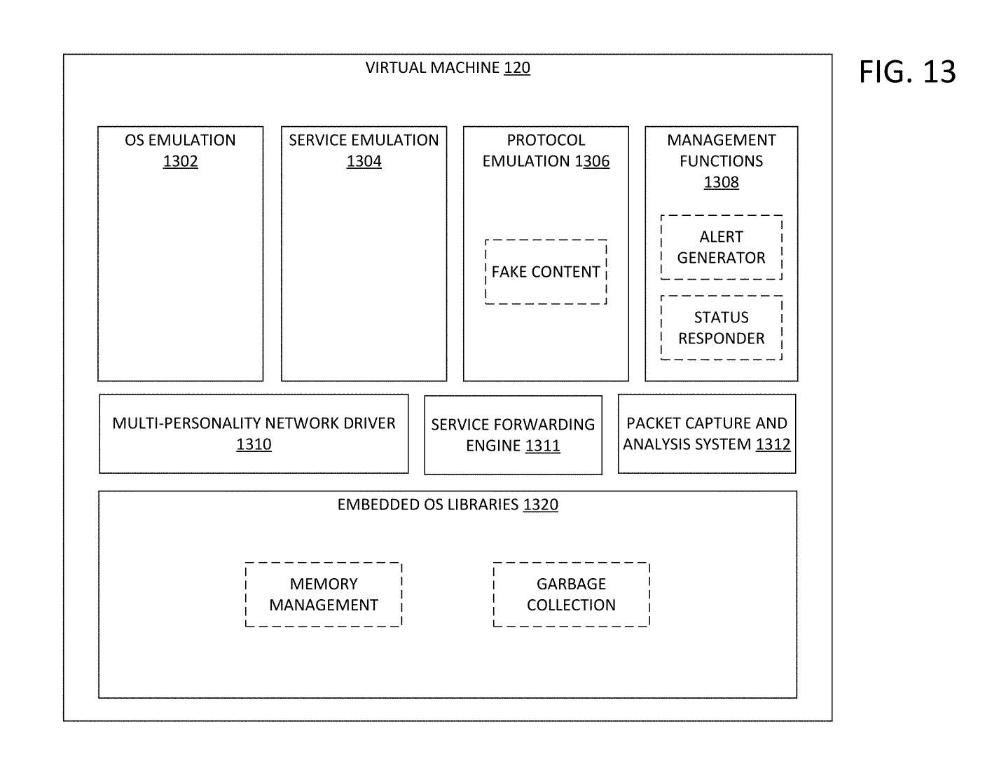

FIG. 13 depicts a block diagram of an exemplary ultra-small unikernel-based VM 120 implementing a fake network device or computing device, with subsystems thereof implementing major functional blocks. Each VM 120 is coupled to an NIC 130, and is configured to appear and communicate on a network as a discrete device, so as to mimic a real network device. VM 120 may be described as a software-based VM, in that it does not include its own dedicated hardware (e.g., it is instead stored in memory of a hardware device). VM 120 may be largely self-contained in its own memory space (e.g., in a dedicated portion of non-transitory memory of the computing device which stores software implementing the VM). Further, VM 120 may be isolated by the virtualization system 165. In the depicted example, VM 120 includes the following components:
a) One or more embedded operating system (OS) libraries 1320 stored in non-transitory memory of a computing device (e.g., computing device 110 shown in FIG. 2) which are configured to compile operating system-like functionality including thread management and application memory management into the VM memory space, in a unikernel implementation. The libraries may include a memory management library, a garbage collection library, protocol libraries, and any number of device drivers. Inside the VM address space, a typical fully-functional OS does not exist. This may include the purposeful exclusion of unneeded components of typical OS such as legacy, unused device drivers, shell programs, file systems, managed code systems, user-space processes thread management, and OS utilities.
b) A multi-personality network driver (or a multi-personality network stack) 1310 which is attached to/communicates with the NIC directly, or through hypervisor/container services. Network driver 1310 is responsible for OS emulation and all IP communications through which the VM performs its function. Further, network driver 1310 is configured to emulate any number of OS through parameterized responses to known OS-fingerprinting probes.
c) A service forwarding engine 1311 which may coordinate with the multi-personality network driver 1310 to forward incoming network traffic from network connection 180 to other honeypots, and to also forward replies to the network infrastructure 106 via network connection 180. In some examples, the service forwarding engine can be configured to forward packets at layer 2 or layer 3 of an Open System Interconnection (OSI) network model, or to proxy connections at layer 4 or above of an OSI network model. The service forwarding engine may also manipulate the values inside packets in order to improve fidelity of the emulation of services. For example, when forwarding packets through many VMs each having a unique MAC address, to a single real network device having only a single MAC, otherwise unmanipulated reply packets may appear to an attacker as if many devices have the same MAC address. The VMs may replace the MAC address in the reply packet with the VMs' MAC address, thereby making it appear to an attacker that each VM was generating the reply.
d) A packet capture and analysis system 1312 that can capture, analyze, store, and forward packet streams captured by the multi-personality network driver 1310. This system can capture and store network packets using industry standard (PCAP) or proprietary formats, analyze them in real time against imported attack signatures, export them for analysis by other tools, and transmit them for analysis by external or third party security tools to provide IDS/IPS functionality.
e) An OS emulation subsystem 1302 configured to implement OS emulation. The OS emulation may be accomplished by responding to network scanning tools that use a variety of techniques to differentiate between devices and operating systems. The scanning tools use techniques including sending various types of network traffic in the form of packets or attempted connections and measuring responses against known responses (fingerprints) for known device types. The OS emulation system replays responses to such scans, drawing from fingerprint databases (sets of parameterized responses associated with specific OSs) or fingerprints generated through fingerprinting tools that can generate fingerprints from specific target devices.
f) A service emulation subsystem 1304 configured to respond to external connections with appropriately-formatted fake services. Examples include Hypertext Transfer Protocol (HTTP), SNMP, Server Message Block (SMB), Network Time Protocol (NTP), and SSH services. Attackers may attempt to log into fake devices using these protocols, or using scanning tools to validate the existence of such services. This subsystem ensures that the fake VMs respond with high-fidelity, if artificial, service inquiry responses.
g) A protocol emulation subsystem 1306 which is responsible for communicating with other VMs, real internal devices, and/or external services (e.g., public-facing web sites), using simulated network protocols. For example, the simulated network protocols may include nearly any network protocol, both standardized and custom. Example common protocols include such popular protocols as HTTP, File Transfer Protocol (FTP), SSH, SNMP, NTP, Telnet, RDP, Lightweight Directory Access Protocol (LDAP), etc. As shown, the protocol emulation subsystem may store fake content and communicate the fake content to other VMs, real internal devices, and/or external services. By communicating over the network, attackers that have gained access to the network traffic stream can intercept these communications to detect and find the VMs, thus misdirecting attack efforts to the fake devices.
h) A management functions subsystem 1308 which receives instructions from a control system (e.g., control system 155 of FIG. 1) and sends alerts to the control system or to an alerting system (e.g., via an Alert Generator function). The management functions subsystem also receives updates on communications protocols, fake content, and fake signatures (e.g., via a Status Responder function).

The OS emulation, service emulation, protocol emulation, and management functions subsystems each represent a set of computer-readable instructions stored in non-transitory memory of the computing device hosting the VM which are executable by a processor (e.g., processor 160 or a processor of control system 155) to perform the functions described above. The unikernel-based virtual machine does not include a legacy operating system (OS) function, such as shell program, file system, user-space processes thread management, and operation system utility.

With the omission of a full OS in the memory space of each VM, the attack surface of a single VM is very small (e.g., relative to the attack surface of a VM which includes a full OS). Additionally, with no OS presence, all common and known OS vulnerabilities are avoided, ensuring that organizations deploying these solutions are not adding risk to their network infrastructures.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as network 100 shown in FIG. 1 and the components thereof. The methods may be performed by executing stored instructions with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

In this application, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. A method for emulating devices communicating over a network, comprising:
generating a network traffic;
recording a network traffic response from a real network device in response to the generated network traffic;
determining a fingerprint and a service from the recorded network traffic response;
inserting the fingerprint and the service into a unikernel-based virtual machine, wherein the unikernel-based virtual machine does not include a legacy operating system (OS) function; and
deploying the unikernel-based virtual machine on the network.

2. The method of claim 1, wherein the unikernel-based virtual machine includes each and every one of a thread management, an application memory management, and an OS library.

3. The method of claim 1, further comprising saving the fingerprint and the service to a file system of a computing device, and wherein the unikernel-based virtual machine is deployed via the computing device.

4. The method of claim 1, further comprising determining a range of IP addresses via user input, application programming interface (API), or command line, and scanning and recording the network traffic response from each of the IP address within the range of IP addresses.

5. The method of claim 4, wherein the scanning and the recording is in response to a change of the network.

6. The method of claim 5, wherein the change of the network comprising new devices added to the network.

7. The method of claim 5, further comprising instructions to detect the network change based on a predetermined schedule.

8. The method of claim 1, further comprising:
storing the fingerprint in a corresponding fingerprint file and store the service in a service file;
displaying the fingerprint file and the service file to a user via a graphical user interface;
receiving user input selecting the fingerprint file and the service file; and
saving the selected files to a file system of a computing device for deploying the virtual machines.

9. A network, comprising:
a plurality of real network devices;
a computing device comprising a processor and a non-transitory memory; and
a host computing device, comprising instructions stored in a non-transitory memory of the host computing device and executable by a processor of the host computing device to:
discover a device on the network;
generate a network traffic;
record a network traffic response from the device in response to the generated network traffic;
determine fingerprints and services of the device based on the recorded network traffic response;
store each determined fingerprint in a corresponding fingerprint file and store each service in a corresponding service file;
display a list of the fingerprint files and service files;
receive user input selecting one or more of the fingerprint files and service files; and
save the selected fingerprint files and service files to the non-transitory memory of the computing device, and
wherein the computing device includes instructions stored in the non-transitory memory of the computing device and executable by the processor of the computing device to:
generate a plurality of unikernel-based virtual machines within the non-transitory memory of the computing device, each virtual machine comprising one of the saved fingerprint files and one or more of the saved service files; and
deploy the unikernel-based virtual machines on the network.

10. The network of claim 9, wherein the device is a new device added to the network.

11. The network of claim 9, wherein each of the plurality of the unikernel-based virtual machines includes one or more of a thread management, an application memory management, and an OS library, and the unikernel-based virtual machine does not include a legacy operating system (OS) function.

12. The network of claim 9, wherein each of the deployed unikernel-based virtual machines includes a service emulation subsystem to respond to external service inquiries based on the saved service file, and an OS emulation subsystem to respond an external network scan based on the saved fingerprint file.

13. The network of claim 9, wherein the names of the fingerprint files and the service files are displayed in a user-selectable list.

14. The network of claim 9, wherein the host computing device further includes instructions to convert the determined fingerprints and services for the unikernel-based virtual machine before storing the determined fingerprints and services.

15. A method for emulating devices communicating over a network, comprising:
a first set of instructions stored in a non-transitory memory of a host computing device and executable by a processor of the host computing device to:
automatically detect a network change in real network devices;
generate network traffic based on the changed network;
record network traffic responses from the real network devices;
determine fingerprints and corresponding services from the recorded network traffic responses;
filter each fingerprint and service based on predetermined rules;
send the filtered fingerprints and the filtered services to a computing device different from the hosting device, and
a second set of instructions stored in a non-transitory memory of the computing device and executable by a processor of the computing device to:
receive and save the filtered fingerprints and the filtered services from the host computing device to a file system of the computing device; and
update deployed unikernel-based virtual machines based on the saved filtered fingerprints and the filtered services.

16. The method of claim 15, wherein detect the network change includes discover a device on the network.

17. The method of claim 15, wherein the predetermined rules include rules to eliminate duplicates of fingerprints or services which are already stored to the file system.

18. The method of claim 15, wherein updating the deployed virtual machines includes adding one or more new unikernel-based virtual machines to the deployed unikernel-based virtual machines and deleting one or more of the deployed unikernel-based virtual machines responsive to the network change.

19. The method of claim 15, wherein the instructions to automatically detect the network change comprise instructions to detect the network change via an external network inventory system, IP address management system, and/or authentication system of a new device added to the network.

20. The method of claim 15, wherein the instructions to automatically detect the network change comprise instructions to detect the network change in response to changes to systems discovered by vulnerability management systems or host-based IDS systems.
